(19) United States
(12) Patent Application Publication
(10) Pub. No.: US 2004/0237233 A1
(43) Pub. Date: Dec. 2, 2004

(54) Dental applicator with high material holding capacity

(76) Inventors: William B. Dragan, Easton, CT (US); John J. Discko, Trumbull, CT (US); Lacy Kennon, East Haven, CT (US)

Correspondence Address: Paul A. Fattibene, Fattibene and Fattibene, 2480 Post Road, Southport, CT, 06890, US

(21) Appl. No.: 10/445,745

(22) Filed: May 27, 2003

(51) Int. Cl. A46B 3/02; B05C 17/00

(52) U.S. Cl. 15/104.94; 15/210.1; 15/160; 15/167.1; 15/209.1; 300/21; 15/DIG. 5

(57) ABSTRACT

An applicator having a plurality of different size fibers capable of retaining a large quantity of liquid material. An applicator having a handle portion and an applicating end portion in which different size fiber material is adhered to the applicating end portion. At least two different size fibers are used, with one being longer than the other. The at least two different lengths of fibers used range from 0.04 inches to 0.100 inches with a denier ranging from three to twenty-five. The use of a plurality of different sized fibers results in an improved applicator having increased liquid retaining properties. The present invention is particularly applicable to medical or dental procedures used in applying a liquid material. The present invention is particularly well suited in a dental procedure for applying a relatively large quantity of self-etching bonding liquid to a prepared cavity in a tooth.

### FIELD OF THE INVENTION

The present invention relates generally to an applicator for applying a material, and more particularly to an applicator having the capacity to hold a large quantity of liquid for applying the liquid to a surface, preferably in a dental procedure.

### BACKGROUND OF THE INVENTION

There are many medical and dental procedures that require the application of a liquid material. Generally, the application of a liquid material has been done by different types of applicators such as applicators having bristle brushes, cotton fibers, foam, flock material, or other absorbent materials placed on the end thereof. Often, these applicators are made to be disposable and therefore are relatively inexpensive. An example of different types of applicators is disclosed in U.S. Pat. No. 6,049,934 entitled “Disposable Dental Applicator” issuing to Discko on Apr. 18, 2000, which is herein incorporated by reference. Therein disclosed is a double ended applicator having a brush, a foam pad, fuzzy ball or other similar or equivalent applicator for applying a liquid, paste or powder.

While these and other applicators have generally been adequate in applying a quantity of liquid material, they often do not hold a sufficiently large quantity of liquid material for different applications or procedures used in the dental and medical fields. For example, in dentistry, the bonding of a filling material to a tooth surface is a common procedure. In many bonding procedures, the enamel and dentine of the tooth is etched in preparation for bonding. Subsequent to etching, a bonding material is applied so that the tooth filling material will better adhere to the enamel of the tooth. However, it has been found that after the restoration of the tooth, the tooth is often sensitive. This sensitivity has often been attributed to the use of a 35% to 40% phosphoric acid etch used on the tooth prior to placement of the bonding liquid. The bonding liquid is often placed on the tooth in small quantities after the etching process. This can cause too little bonding liquid to be applied leaving the dentin inadequately protected and result in sensitivity. However, in some restoration techniques, the etching step has been eliminated and a self etching bonding liquid utilized. While the use of a self etching bonding liquid has helped to reduce or eliminate possible post restoration sensitivity of the tooth, the use of the self etching bonding liquid requires the placement of much larger quantities of liquid material. The larger quantities of self-etching bonding liquids required makes application of the required quantity of liquid material with prior applicators problematic. The need for a relatively small applicator, in combination with the need for applying a relatively large volume of liquid, results in prior applicators being unable to hold the volume of liquid required in some dental procedures requiring a large volume of liquid. Additionally, in some applications, in particular in the use of self-etching bonding liquids, it is necessary to vigorously rub the tooth with the applicator containing the liquid material. For many types of applicators, this is not practical.

Therefore, there is a need for an applicator that has the capacity to hold a large quantity of liquid material, which can be used in different medical and dental procedures.

### SUMMARY OF THE INVENTION

The present invention comprises an applicator with the capability to hold a large quantity of liquid material for medical or dental procedures. The applicator comprises a handle and an absorbent end placed thereon, with the absorbent end being comprised of different size fibers. Preferably, the different size fibers are a flocked material having a length greater than 0.040 inches and less than 0.100 inches with a denier ranging between 3 and 25. In one embodiment, the flocked end comprises two different types of flocking fiber material, with one being shorter and finer than the other. In one preferred embodiment, the shorter, finer fiber has a length between approximately 0.040 and 0.060 inches and a denier of approximately 6, and the other, longer fiber has a length of between approximately 0.080 and 0.090 inches with a denier of approximately 20.

Accordingly, it is an object of the present invention to provide an applicator capable of holding a large quantity of liquid for use in medical or dental procedures.

It is another object of the present invention to provide an applicator that is relatively easily manufactured and is made readily disposable.

It is a further object of the present invention to provide an applicator capable of applying a self-etching bonding liquid to a tooth.

It is an advantage of the present invention that a large quantity of liquid material may be applied in a single application.

It is yet another advantage of the present invention that the need for re-dipping an applicator in a reservoir of liquid material is prevented, reducing the possibility of cross-contamination of the reservoir of liquid material.

It is a feature of the present invention that multiple different size fibers are used.

It is another feature of the present invention that a short and long fiber is combined in an applicator having a flocked end.

These and other objects, advantages, and features become readily apparent in view of the following, more detailed description.

### BRIEF DESCRIPTION OF THE DRAWINGS

FIG. 1 schematically illustrates an applicator of the present invention.

FIG. 2 schematically illustrates the use of an applicator according to the present invention in a dental procedure.

FIG. 3 is a cross section of the applicating end portion of an applicator according to the present invention.

FIG. 4 schematically illustrates the applicating end of another embodiment of the applicator of the present invention.

FIG. 5 schematically illustrates the applicating end of another embodiment of the applicator of the present invention.

FIG. 6 is a block diagram illustrating the method steps of making an applicator according to the present invention

### DETAILED DESCRIPTION OF THE PREFERRED EMBODIMENTS

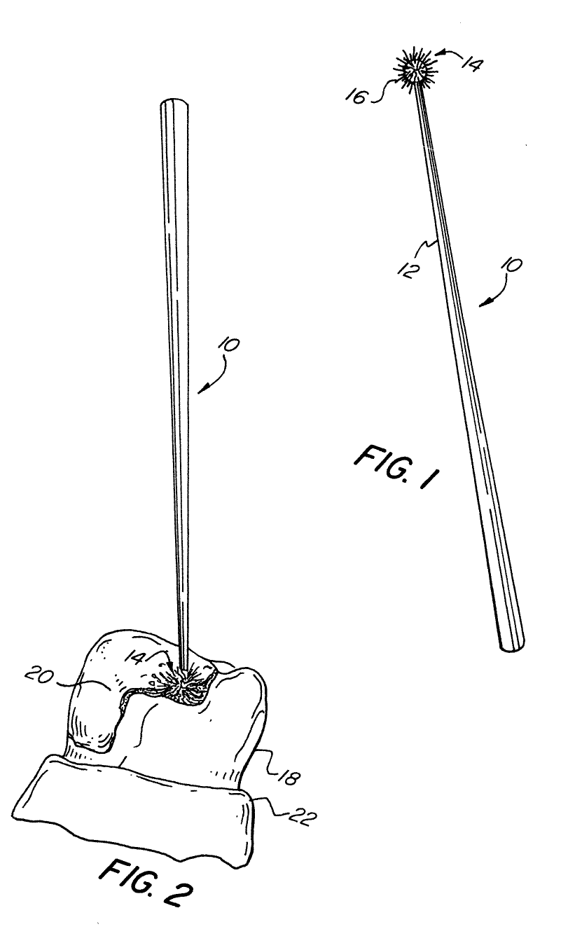

FIG. 1 illustrates an applicator 10 used in applying a liquid material. The applicator 10 comprises a handle portion 12 and an applying or applicating end portion 14. The applicating end portion 14 comprises a plurality of different size fibers. The different size fibers may be made of any type of natural or synthetic material, such as cotton or plastic, or other equivalent. The different size fibers are preferably a flock material having a longitudinal length greater than 0.04 inches or 0.102 centimeters and less than 0.100 inches or 0.254 centimeters with a denier ranging from between 3 and 25. By different size fibers it is meant a fiber that has a different dimension, in either length or width. The preferred ratio of the length of the shortest fiber to the longest fiber ranges between approximately 0.40 and 0.75.

FIG. 2 illustrates the application of the present invention in a dental procedure. An applicator 10 has an applicating end portion 14 containing a quantity of liquid material. The liquid material may be any material, but in this embodiment it is preferably a self-etching bonding liquid. The applicator 10 is used to apply an ample amount of the self-etching bonding liquid to a prepared cavity 20 formed in the tooth 18. The tooth 18 is held in the bone and covered by gingiva 22 in a patient's mouth. The prepared cavity 20 is generally formed in the process of removing decay or caries in a tooth. Generally, a drill is used to remove the decay or caries and portions of the enamel of the tooth 18 in the process of restoring the tooth. Often, a relatively large quantity of self-etching bonding liquid is necessary in treating the prepared cavity 20 for receiving a restorative material. Therefore, the applicating end portion 14 is desirably as absorbent as possible for holding the required relatively large quantity of self-etching bonding liquid used in preparing the tooth 18.

The applicating end portion 14 may have a spherical plastic end to which the flock 16 is adhered. The spherical end, in combination with the flock 16, aids in the use of the applicator 10 in vigorously rubbing the prepared cavity 20 with the self-etching bonding liquid. After application of the self-etching bonding liquid, a restorative material, not illustrated, is placed within the prepared cavity 20 for restoring the tooth 18.

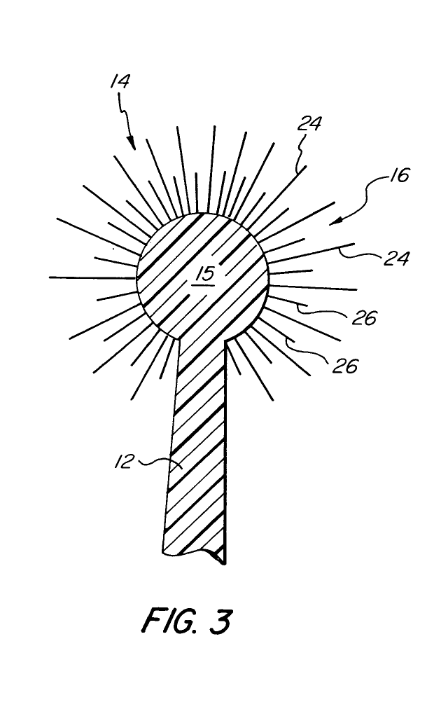

FIG. 3 is an enlarged view better illustrating the applicating end portion 14. The applicating end portion 14 comprises a plurality of different size fibers 16, which may be of a flocking type of fiber or material. One of the pluralities of different types of fibers 16 is a long fiber 24. The long fiber 24 preferably has a longitudinal length less than 0.100 inches or 0.254 centimeters with a denier less than twenty-five. Another one of the plurality of different types of fibers 16 is a shorter fiber 26. The shorter fiber 26 preferably has a longitudinal length greater than 0.04 inches or 0.102 centimeters and a denier greater than 3. A denier is a unit of fineness for a fiber and is generally defined as a unit expressing the mass of a fiber divided by its length, equal to one gram for nine thousand meters of fiber. The plurality of different sized fibers 16 are adhered to a spherical end 15 attached to the handle 12.

It has been determined that the use of short fibers 26 in combination with long fibers 24 produces an improved applicator having enhanced liquid retaining properties. By providing a mix of different size fibers, it has been discovered that an applicator can be produced having sufficiently stiff bristles or fibers to maintain its shape and application properties, together with the capability of holding an increased quantity of liquid material. The preferred ratio of the length of the short and long fibers ranges between two-fifths and three-quarters, or between 0.40 and 0.75 with a denier ranging between 3 and 25.

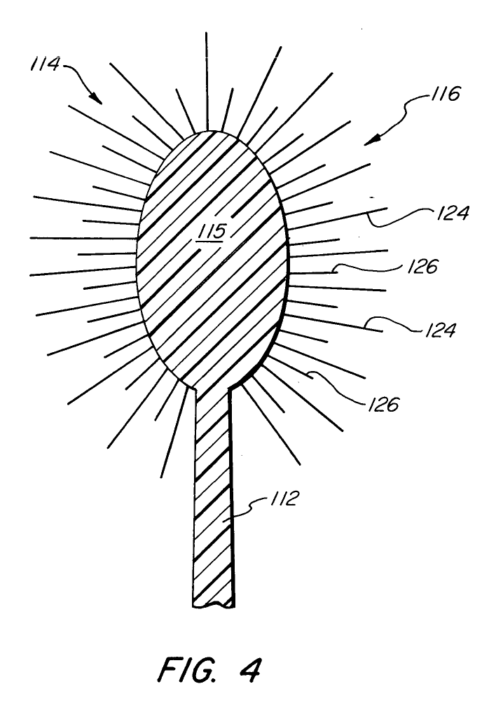

FIG. 4 schematically illustrates another embodiment of the present invention having a different shaped applicating end portion. The applicating end portion 114 in this embodiment has an oblong or oval end 115. Adhered to the oblong end 115 is a plurality of different sizes fibers 116. The different sized fibers 116 are comprised of long fibers 124 and short fibers 126. The range in sizes of the plurality of different size fibers 116 in this embodiment is similar or the same as the range described in reference to FIG. 3. The oblong end 115 is attached to a handle portion 112. The oblong end 115 has the advantage of providing more surface area, and therefore a greater quantity of different shaped fibers 116 having the capability of holding more liquid material. Additionally, the oval shape of the applicating end portion 114 has an advantage in permitting the applicator to fit into smaller areas or holes than a similar capacity spherical ended embodiment, as illustrated in FIG. 3.

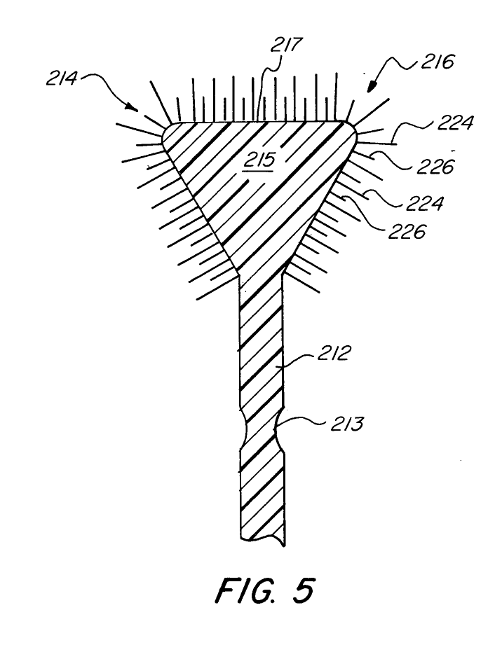

FIG. 5 schematically illustrates another embodiment of the present invention having a different shaped applicating end portion. The applicating end portion 214 in this embodiment has a shaped end 215 with a flat portion 217. Adhered to the shaped end 215 is a plurality of different sizes fibers 216. The different sized fibers 216 are comprised of long fibers 224 and short fibers 226. The range in sizes of the plurality of different size fibers 216 in this embodiment is similar or the same as the range described in reference to FIGS. 3 and 4. The shaped end 215 is attached to a handle portion 212. The handle portion 212 may have a reduced lateral dimension portion 213 to facilitate bending of the handle portion 212 relative to the applicating end portion 214. The shaped end 215 has the advantage of providing a flat portion 217 that facilitates scrubbing. The relatively broad flat portion 217 greatly facilitates the ability to apply some pressure to an area of application.

The applicators according to the present invention may be manufactured by any conventional flocking technique. Generally, flocking is accomplished by applying an adhesive to the end to which the flocking material is to be attached and electrostatically charging the flocking material and the material on which the flock is to adhere during application of the flocking material. In a method of manufacturing the applicators according to the present invention, the different sized fibers may be combined together and applied simultaneously to the applying end portions of the different embodiments of the present invention. However, it has been found to be advantageous to first apply the longer flocking fiber material and subsequently to then apply the shorter fiber flocking material. The method of sequentially applying the different sized fiber materials has been found to provide improved, more consistent results resulting in applicators having increased liquid retaining capacity.

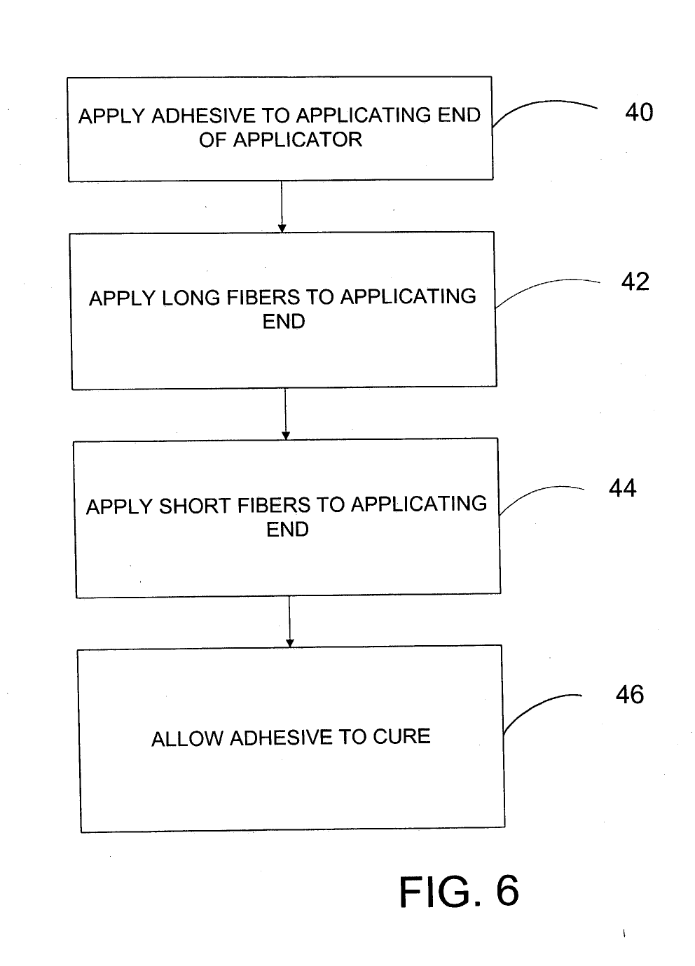

FIG. 6 is a block diagram illustrating the method steps in an embodiment of the present invention. Box 40 represents the step of applying an adhesive to the applicating end of an applicator. Box 42 represents the step of applying long fibers to the applicating end. The long fibers have a length preferably greater than 0.06 inches and less than 0.10 inches with a denier greater than 3, and preferably about 20. The long fibers are preferably applied by conventional flocking type techniques using electrostatic charges to attract the long fibers to the applicating end. Box 44 represents the steps of applying short fibers to the application end. The short fibers are applied to the applicating end preferably after the long fibers have been applied. The short fibers are also applied using conventional flocking type techniques. The short fibers have a length preferably greater than 0.04 inches and less than 0.080 and a denier greater than 3, and preferably about 6. Box 46 represents the step of allowing the adhesive to cure or dry.

Accordingly, the different embodiments of the present invention, in combining different size fibers to a flocked applicator, makes possible the holding and application of a larger quantity of liquid material. This is advantageous in many medical procedures in which a relatively large quantity of liquid material is desired to be applied, and particularly in a dental procedure that requires the application of a self-etching bonding liquid. Additionally, the possibility of cross-contamination of a supply of liquid material is reduced by eliminating the need for re-dipping the applicator in the reservoir of liquid material to obtain more liquid material for applying.

While the present invention has been described with respect to several embodiments, it should be obvious to those skilled in the arts that various modifications may be made without departing from the spirit and scope of this invention.

What is claimed is:

1. An applicator for applying a material comprising:
a handle portion;
an applicating end portion attached to said handle portion; and
a plurality of different size fibers attached to said applicating end portion,
whereby a quantity of material is capable of being held by aid plurality of different size fibers attached to said applicating end portion and applied to a surface.

2. An applicator for applying a material as in claim 1 wherein:
said plurality of different size fibers have a length ranging from between substantially 0.04 inches and 0.100 inches.

3. An applicator for applying a material as in claim 1 wherein:
said plurality of different size fibers have a denier ranging from between substantially three and twenty-five.

4. An applicator for applying a material as in claim 1 wherein:
said plurality of different size fibers have a length ranging from between substantially 0.04 inches and 0.100 inches and a denier ranging from between substantially three and twenty-five.

5. An applicator for applying a material as in claim 1 wherein:
a ratio of a first length of a shortest one of said plurality of different size fibers and a second length of a longest one of said plurality of different size fibers ranges between approximately 0.40 and 0.75.

6. An applicator for applying a material as in claim 1 wherein:
said applicating end portion comprises a spherical shape.

7. An applicator for applying a material as in claim 1 wherein:
said applicating end portion comprises an oval shape.

8. An applicator for applying a material as in claim 1 wherein:
said applicating end portion comprises a flat portion.

9. An applicator for applying a material as in claim 8 wherein:
the flat portion is formed on said applicating end portion opposite said handle portion.

10. An applicator for applying a liquid material comprising:
a handle portion;
an applicating end portion attached to said handle portion, said applicating end portion comprising a shaped end;
a plurality of long fibers having a long length greater than 0.70 and less than 0.100 inches attached to the shaped end; and
a plurality of short fibers having a short length less than 0.07 and greater than 0.04 inches attached to the shaped end adjacent to said plurality of long fibers,
whereby a quantity of the liquid material is capable of being held by said plurality of long and short fibers attached to said applicating end portion and applied to a surface.

11. An applicator for applying a liquid material as in claim 10 wherein:
said plurality of long fibers have a denier greater than eight and less than twenty-five; and
said plurality of short fibers have a denier less than eight.

12. An applicator for applying a liquid material as in claim 10 wherein:
said shaped end is spherical.

13. An applicator for applying a liquid material as in claim 10 wherein:
said shaped end is oval.

14. An applicator for applying a liquid material as in claim 10 wherein:
said shaped end has a flat portion.

15. An applicator for applying a liquid material as in claim 10 wherein:
a ratio of the short length and the long length ranges between approximately 0.40 and 0.75.

16. An applicator for applying a liquid material comprising:
a handle portion;
an applicating end portion attached to said handle portion, said applicating end portion comprising a shaped end;
a plurality of long fibers having a long length attached to the shaped end; and
a plurality of short fibers having a short length attached to the shaped end adjacent to and intermixed with said plurality of long fibers,
wherein a ratio of the short length to the long length ranges between 0.40 and 0.75,
whereby a quantity of liquid material is capable of being held by said plurality of long and short fibers attached to the shaped end of said applicating end portion and applied to a surface.

17. An applicator for applying a material comprising:
a handle portion;
an applicating end portion attached to said handle portion;
a flat surface portion formed on said applicating end portion; and
a plurality of different size fibers attached to said applicating end portion,
whereby a quantity of material is capable of being held by said plurality of different size fibers attached to said applicating end portion and applied to a surface with said flat surface portion.

18. An applicator for applying a liquid comprising:
a handle portion;
an applicating end portion attached to said handle portion;
adhesive attached to said applicating end portion;
a plurality of long fibers attached to said adhesive on said applicating end portion, said plurality of long fibers having a length substantially 0.08 inches and a denier of substantially twenty; and
a plurality of short fibers attached to said adhesive on said applicating end portion, said plurality of short fibers having a length substantially 0.06 inches and a denier of substantially six,
whereby a quantity of the liquid is capable of being held by said plurality of long and short fibers attached to said adhesive on said applicating end portion and applied to a surface.

19. A method of making an applicator comprising the steps of:
applying adhesive to an application end portion of the applicator;
applying a plurality of first fibers having a first size to the adhesive on the applicating end portion of the applicator;
applying a plurality of second fibers having a second size to the adhesive adjacent to the plurality of first fibers, the first size being different than the second size; and
curing the adhesive,
whereby the applicator is capable of holding a quantity of material to be applied to a surface is formed.

20. A method of making an applicator as in claim 19 wherein:
the first and second size comprises a first and second length, and the first length is greater than the second length.

21. A method of making an applicator as in claim 20 wherein:
said step of applying the plurality of first fibers precedes said step of applying the plurality of second fibers.
